(19) United States
(12) Patent Application Publication
(10) Pub. No.: US 2001/0013201 A1
(43) Pub. Date: Aug. 16, 2001

(54) Rotational tilt-armature

(75) Inventors: Walter Renz, Ditzingen (DE); Michael Neuwirth, Ditzingen (DE)

Correspondence Address: Dreiss, Fuhlendorf, Steimle & Becker, Postfach 10 37 62, D-70032 Stuttgart, DE

(73) Assignee: Gretsch-Unitas Gmbh, Ditzingen (DE)

(21) Appl. No.: 09/761,574

(22) Filed: Jan. 18, 2001

(30) Foreign Application Priority Data
Feb. 11, 2000 (DE) 200 02 467.1

(51) Int. Cl. E05F 11/24; E05F 15/02; E05F 15/10; E05D 15/52

(52) U.S. Cl. 49/192; 49/340; 49/341; 49/342

(57) ABSTRACT

The invention concerns a rotational tilt-armature for a window, a door or the like comprising a transmission (32), groove bands and locks (74, 92). The rotational tilt armature has a rotational armature (22) and a tilt armature (24) and the transmission is formed of two parts and comprises a drive (18) for the rotational armature (22) and a drive (20) for the tilt armature (24). The rotational armature (22) and the tilt armature (24) can be driven one after the other.

This application claims Paris Convention priority of DE 200 02 467.1 filed on Feb. 11, 2000 the entire disclosure of which is hereby incorporated by reference.

### BACKGROUND OF THE INVENTION

The invention concerns a rotational tilt-armature for a window, a door or the like comprising a transmission, groove bands and locks.

Armatures of this kind are described in the following patent literature: EP 0874 751 B1, U.S. Pat. No. 4,035,953, U.S. Pat. No. 4,339,892 and GB 214 76 57 A the entire disclosures of which are hereby incorporated by reference.

Windows or doors which can be rotated (pivoted) about a vertical axis and also be tilted about a horizontal axis are well known. These windows or doors have a rotational tilt-armature which is driven via a transmission operated by a handle to displace the groove bands in the window or door frame. The turning handle usually has three positions with one position being the closed position from which the turning handle can be rotated through 90° into the rotational position. In this rotational position, the window or door can be pivoted about the vertical axis and be opened. If the turning handle is pivoted further by 90°, with the door or window closed, the armature is in its tilting position and the door or window can then be tilted about a horizontal axis The door or window is usually held by bracket tongs which engage on the upper edge of the door or window. Disadvantageously, the tilted door or window cannot assume an intermediate position, i.e. can be tilted only until the bracket tongs limit the tilting motion.

It is therefore the underlying purpose of the invention to provide a rotational tilt-armature which permits tilting of the door or window into intermediate positions.

### SUMMARY OF THE INVENTION

This purpose is solved in accordance with the invention in that a rotational tilt-armature of the above mentioned type is provided with a rotational armature and a tilt armature, wherein the transmission is formed of two parts and comprises a drive for the rotational armature and a drive for the tilt armature. The rotational armature and the tilt armature can be driven one after the other.

In the inventive rotational tilt-armature, the door or window is released via the rotational armature to effect the rotational position. Towards this end, only the rotational armature is driven by a separate drive. For tilting the door or window, the rotational armature is brought into its other end position which is opposite to the locked position and in which a side of the door or window is secured to the fixed casement about which the door or window is to be tilted. When the rotational armature is in this end position, the tilt armature is driven and the door or window is gradually brought from its closed position within the fixed casement into its tilted position. The further the tilt armature is driven, the larger the opening angle of the tilted door or window. The rotational tilt-armature in accordance with the invention permits greater or less tilting of the door or window in dependence on the extent to which the tilt armature is driven. When the tilt armature is in its other end position opposite to the closed position, the door or window assumes its fully tilted position.

It must be emphasized that tilting of the door or window is not effected through the rotational armature (which drives the locking mechanism). Tilting of the door or window is effected through a separate tilt armature which is driven independently of the rotational armature.

The rotational armature can preferably be driven when the tilt armature assumes a neutral position and vice versa. The rotational armature and the tilt armature cannot be driven at the same time but only one after the other, i.e. one armature can be driven only when the other armature assumes its neutral position.

In accordance with an embodiment, the transmission comprises a central translating part which drives a first translating part for the rotational armature and a second translating part for the tilt armature. The central translating part is driven e.g. via a central drive, e.g. a turning handle, a crank or the like. The first translating part and subsequently the second translating part are moved, by means of the central translating part, via which the rotational armature and then the tilt armature are driven. The translating parts have the essential advantage that they are relatively flat and can therefore be easily accommodated in the door or window frame.

In accordance with an embodiment of the invention, the first and second translating parts are coupled to the central translating part such that the central translating part always moves only one of the two other translating parts. Coupling or decoupling of the two translating parts to or from the central translating part is effected by means of a coupling which automatically couples one translating part when the other translating part is in the corresponding end position and is decoupled. The drive motion is then transferred e.g. from the rotational armature to the tilt armature or vice versa.

Another embodiment provides that the transmission can be driven via a crank. A crank advantageously permits finer adjustments, as is particularly advantageous for tilting the door or window. In this fashion, it is possible to set almost any intermediate position between the completely closed and completely tilted position of the door or window. The transmission can also be driven via a motor to permit remote control tilting of the door or window.

The transmission preferably comprises a toothed gearing, in particular a differential gearing. Differential gearing are widely known and have the advantage that transmission of relatively large forces is possible. The lever arm of the crank can therefore be relatively short. Tilting and closing of relatively heavy doors or windows is still possible.

The rotational armature and tilt armature are coupled to the transmission in that the rotational armature comprises a first toothed rack section and the tilt armature a second toothed rack section which are part of the transmission. The transmission directly engages, via the toothed rack sections, the rotational armature and tilt armature and displaces same in the door or window frame. It must be noted that either the rotational armature or the tilt armature are driven and each are driven one after the other.

In a preferred embodiment, the drive for the rotational tilt-armature comprises a housing and the toothed rack sections are disposed next to or on top of one another within the housing and are driven by two toothed wheels disposed one on top of the other. The two toothed wheels are motion-coupled. The two toothed wheels have teeth on a portion of their circumference and successively engage the toothed racks, one after the other. These two toothed wheels, which are preferably commonly driven, first move one toothed rack section from its first end position into its second end position and the other toothed rack section is then driven and brought from its first end position into its second end position. During this motion, the rotational tilt-armature is brought from that position locking the door or window into its position completely opening the door or window.

A further development provides that each of the two toothed rack sections can be fixed to the housing of the rotational tilt-armature via a locking device such that only one toothed rack section can be driven via the transmission. The locking device prevents simultaneous movement of the two toothed rack sections. The non-driven toothed rack section is preferably secured with respect to undesired displacement, thereby ensuring that the toothed rack sections assume their neutral positions when the drive changes from one toothed rack section to the other. The same is true for the above-mentioned translating parts.

In accordance with a preferred embodiment, the locking device comprises a locking element which is driven by a toothed rack section and connects the other toothed rack section to the housing and vice versa. This locking element is driven by a toothed rack section every time same reaches its neutral or end position. Then, the other toothed rack section is released such that it can leave its end position thereby locking the other toothed rack section in the previously assumed end position. This locked toothed rack section is released only when the other toothed rack section has returned into its end position and releases the locking element.

The locking element may e.g. be a sphere or a cylindrical roller which engages in openings of the toothed rack section. Since the sphere or roller is fixed by the housing, that toothed rack section into which the sphere or roller engages is fixed.

In accordance with a preferred embodiment, the locking element assumes an unlocking position for each change from one drive for the rotational armature to the other drive for the tilt armature or vice versa. The two armatures are always in their end position such that the two armatures are not driven simultaneously.

The tilt armature preferably comprises a pivoting shackle which is provided in the region of the transmission. The door or window is tilted about the horizontal axis and out of the casement via this pivoting shackle. The bracket tongs provided on the upper side are no longer required for this purpose, rather merely optionally serve to secure and guide the door or window.

For tilting the door or window about a vertical axis when the armature assumes the rotational position, the free end of the shackle can be hooked into a closing plate provided on the fixed casement. The closing plate consists of two parts, with one part being formed by a translating part which opens and closes the closing plate. When the closing plate is open, the free end of the shackle, in particular a pin provided at the free end, can be hooked into the closing plate and fixed therein. The closing plate is always open when the rotational armature assumes its released position and the locks are opened such that the door or window can be turned about the vertical axis.

The shackle is preferably detachably mounted on the tilt armature and can be replaced by a longer or shorter shackle to thereby permit definition of the maximum opening angle of the door or window or adjustment of the opening angle to doors or windows of different heights.

Further advantages, features and details of the invention can be extracted from the dependent claims and the following description which describes in detail two particularly preferred embodiments with reference to the drawing. The features shown in the drawing and mentioned in the claims and in the description may be important to the invention either individually or collectively in any arbitrary combination.

### BRIEF DESCRIPTION OF THE DRAWING

FIG. 1 shows a perspective view, partly broken away, of a crank rotational-tilt armature mounted to a door or window frame;

FIG. 2 shows a view in the direction of arrow II according to FIG. 1 onto the lower side of the frame profile;

FIG. 3 shows a view in the direction of arrow III according to FIG. 1 with removed housing;

FIG. 4 shows a perspective illustration of the crank rotational-tilt armature without housing and without door or window frame;

FIG. 5 shows a perspective view onto the shown crank rotational-tilt armature according to FIG. 1, however, without housing and door or window frame;

FIG. 6 shows a side view of a door or window frame in the closed and tilted positions;

FIG. 7 shows a perspective representation of an embodiment of a differential transmission;

FIG. 8 shows a view in the direction of arrow VIII according to FIG. 7 onto the differential transmission; and

FIG. 9 shows an exploded view of a further embodiment of a drive.

### DESCRIPTION OF THE PREFERRED EMBODIMENT

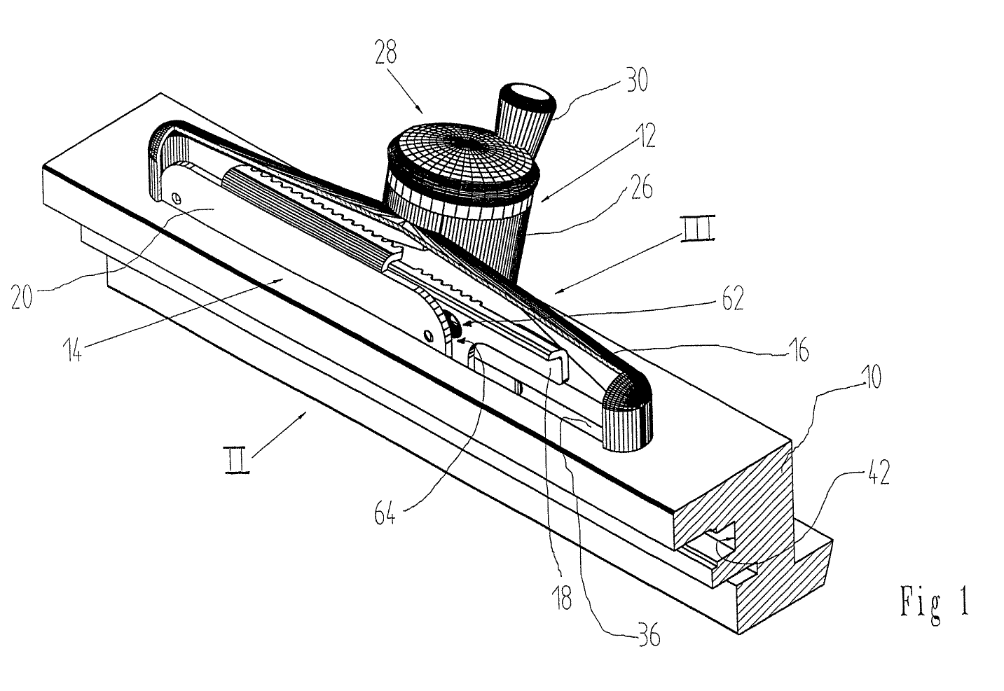

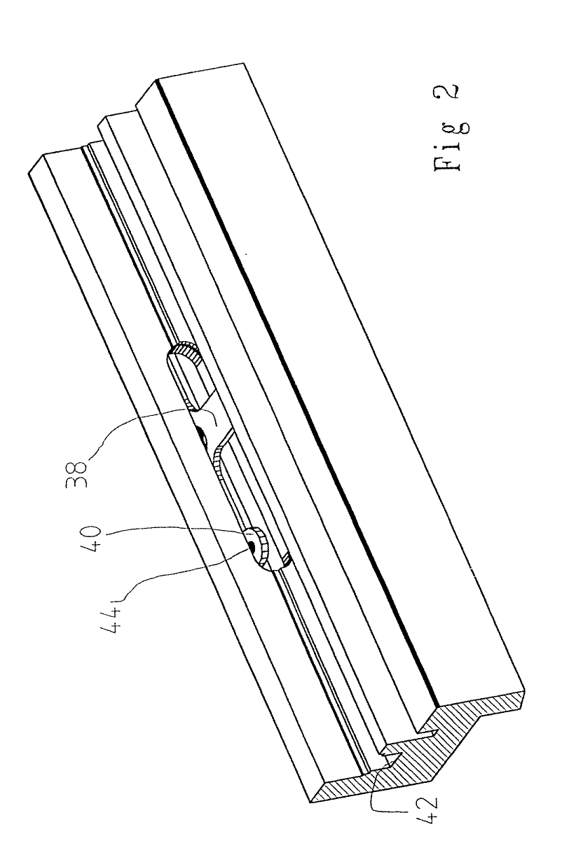

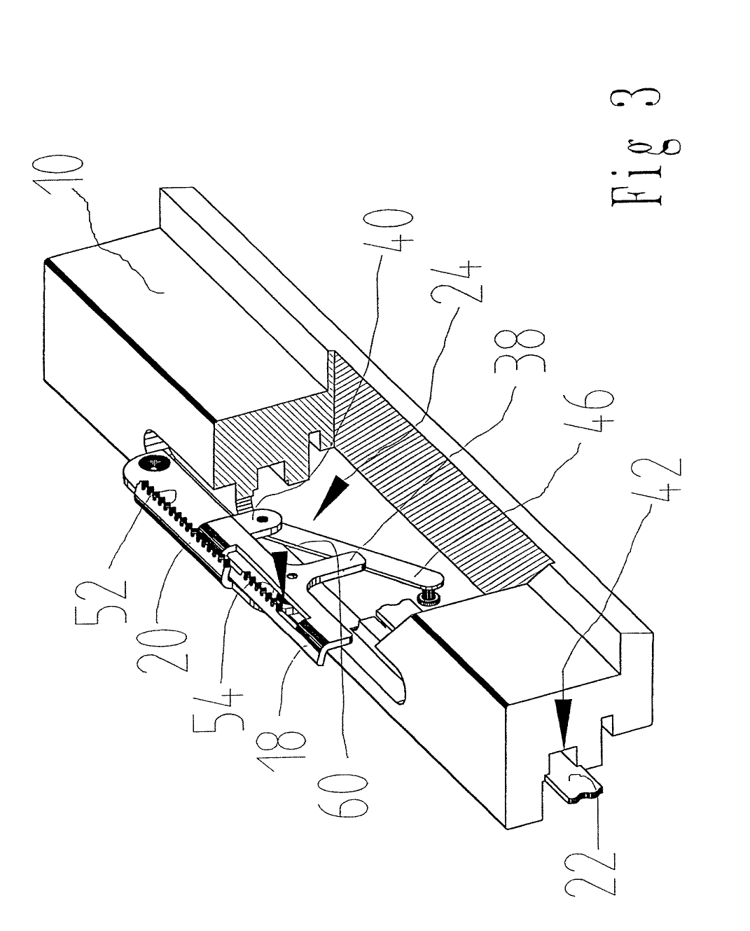

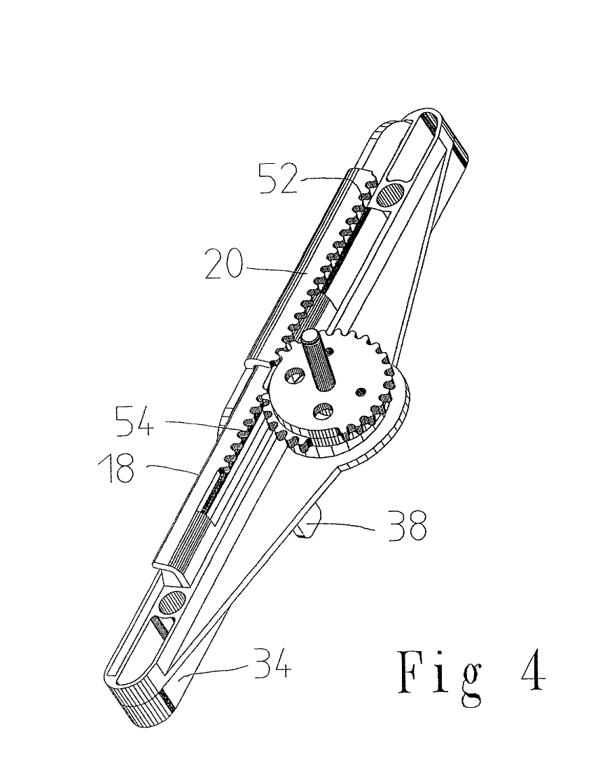

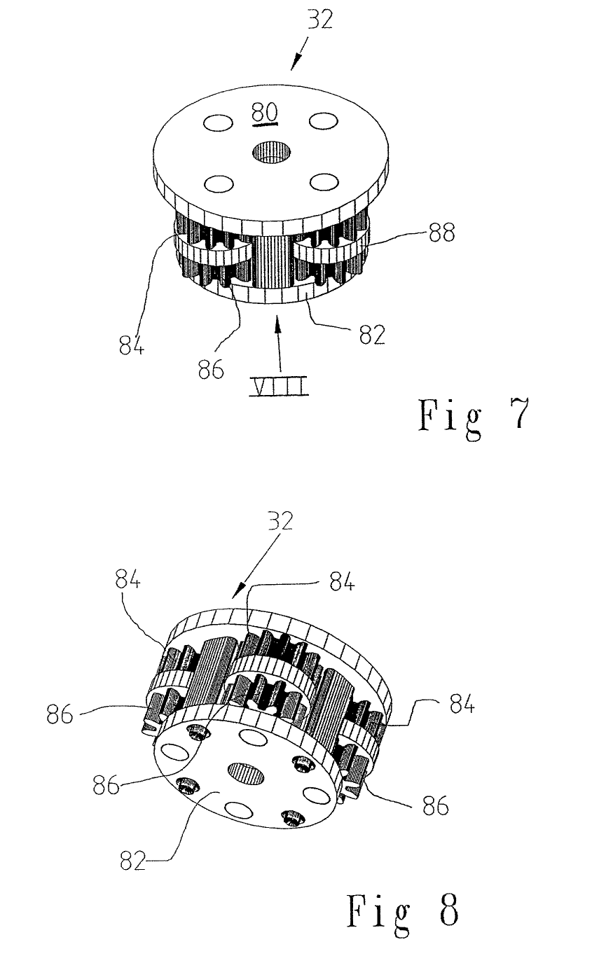

FIG. 1 shows a perspective view of part of a door or window frame 10 on which the housing 12 of a first embodiment of a drive for a crank rotational tilt-armature 14 has been mounted. The housing 12 is partly broken away such that parts of the crank rotational tilt-armature 14 are visible. The housing 12 comprises a longitudinal section 16 accommodating two drives 18 and 20 for a rotational armature 22 or tilt-armature 24 (shown in FIG. 3). On the side next to the longitudinal section 16, there is a cylindrical section 26 in the direction of a sheet of glass (not shown) on which a crank 28 is disposed. The crank 28 is provided with a crank handle 30 for actuating the rotational-tilt armature 14. A differential transmission 32, for driving the drives 18 and 20, is provided within the cylindrical section 26 (shown in more detail in FIGS. 7 and 8).

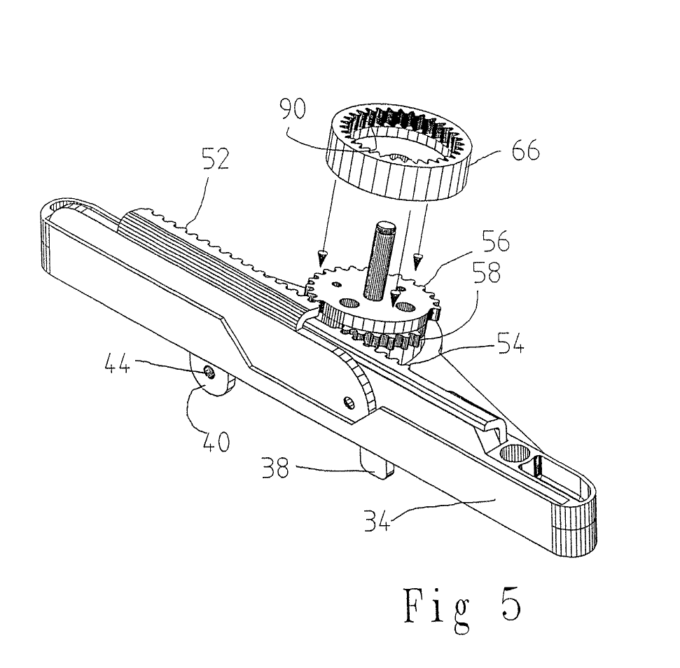

The two drives 18 and 20 are coupled but can only be longitudinally displaced one after the other, i.e. in the longitudinal direction of the door or window frame 10 and within a guiding bed 34 (shown in FIG. 5). This guiding bed 34 has a longitudinal structure and is inserted into a matching recess 36 in the door or window frame 10.

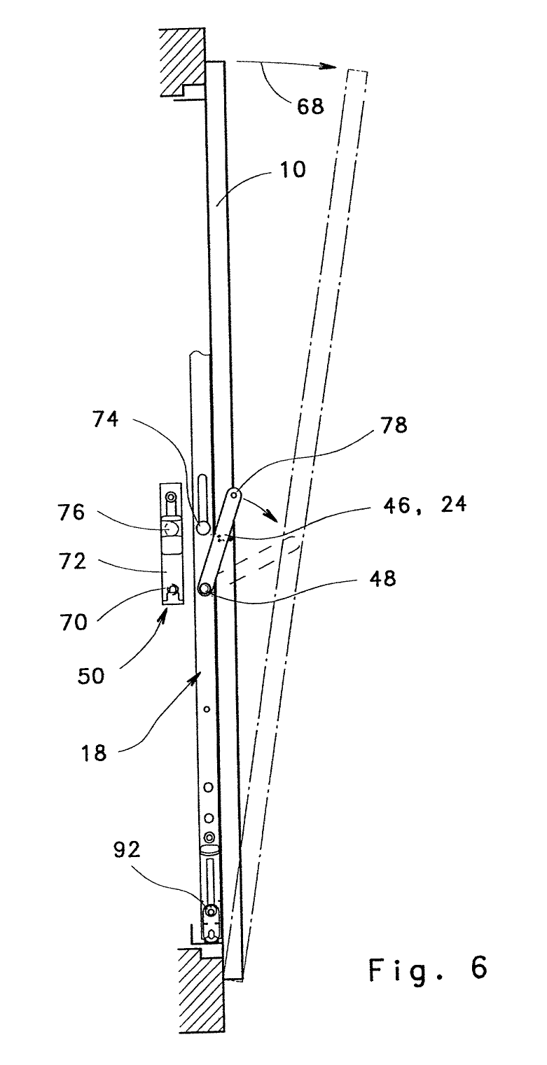

Each of the two drives 18 and 20 has, at their lower sides, a projection 38 and 40, respectively, for actuating the armatures 22 and 24. The projection 38 engages the conventional rotational armature 22 thereby permitting displacement of same in the armature groove 42 within the door or window frame 10. The rotational armature 22 corresponds to conventional armatures of rotational tilt windows. The projection 40 has an eye 44 for mounting a shackle 46 e.g. by means of a rivet, pin or the like. The shackle 46 is schematically shown in FIGS. 3 and 6 and is hooked with its free end 48 into a closing plate 50 located on the fixed casement (FIG. 6).

As is clearly shown, each of the two drives 18 and 20 comprises a toothed rod section 52 and 54 into which the teeth of two toothed wheels 56 and 58 engage (FIG. 5). The two toothed wheels 56 and 58 may be formed from one or two pieces. Only a portion of the circumference of the two toothed wheels 56 and 58 has teeth. On those sections where one toothed wheel has no teeth, the other toothed wheel is provided with teeth. This ensures that, during rotation of both toothed wheels 56 and 58 (which are connected to one another for secure mutual rotation), either the one toothed rod section 52 or the other toothed rod section 54 is moved. If e.g. the toothed wheel 56 of FIG. 5 is rotated in a counter-clockwise direction, the toothed wheel 58 comes out of engagement with the toothed rod section 54 and the teeth of the toothed wheel 56 engage in the teeth of the toothed rod section 52 and move same from the upper left to the lower right (in the arrangement according to FIG. 5). The teeth of the toothed wheel 56 correspondingly disengage the toothed rod section 52 when the toothed wheel 56 is turned in a clock-wise direction, wherein the teeth of the toothed wheel 58 engage the toothed rod section 54 and move same from the lower right to the upper left. The respective other toothed rod section is then in neutral.

FIGS. 1 and 3 show conical recesses 60 and 62 provided in the drives 18 and 20. The guiding bed 34 has an arm (not shown) disposed between the two drives 18 and 20 and having a further recess in which a sphere is disposed. The diameter of the sphere is larger than the separation between the two drives 18 and 20 such that the sphere, which laterally protrudes past the guiding bed 34 arm in which it is held, engages into the two recesses 60 and 62. When one of the two drives 18 or 20 is moved, the recess 60 or 62 is moved out of the alignment shown in FIG. 1 thereby pushing the sphere out of this recess 60 or 62 and disposing it into the other recess 62 or 60. This means that the drive into which the sphere engages is locked via the sphere to the guiding bed 34 arm. The other drive is freely movable. As soon as the two recesses 60 and 62 are once more aligned, the other drive can be moved out of this neutral position, wherein the sphere is displaced into the recess of the other drive such that this other drive is locked to the guiding bed 34 arm. The recesses 60 and 62 and the sphere form a locking element 64 to ensure that only one of the drives 18 and 20 can be moved.

FIG. 5 also illustrates a hollow wheel 66 which is part of the differential transmission 32 and is disposed on the two toothed wheels 56 and 58 for secure mutual rotation therewith. The hollow wheel 66 can thereby connect the two toothed wheels 56 and 58 should this not already have been effected.

FIG. 6 shows a side view of the door or window frame 10 in a closed and tilted position. The door or window frame 10 can be tilted in the direction of arrow 68. The door or window frame 10 is thereby moved and retained by the shackle 46 forming the tilt armature 24. The free end 48 of the shackle 46 comprises a pin held in the locking element 50, which is located in a recess 70 located on the fixed casement. The closing plate 50 is shown separately in FIG. 6 for reasons of clarity. The closing plate 50 is usually in the plane of the tilt armature 18, i.e. in the plane of the armature groove of the door or window frame 10. The closing plate 50 comprises a translating part 72 for opening and closing the recess 70 to capture or release the pin provided at the free end 48. In FIG. 6, the translating part 72 is in the closed position and is displaced by means of a locking pin 74 of the rotational armature from its released position into its open position and back. The locking pin 74 engages into a corresponding pin recess 76 when the door or window frame 10 is closed.

When the free end 48 of the shackle 46 is locked in the closing plate 50 and is therefore stationary, and the drive 20 is moved in FIG. 1 from the upper left to the lower right, the projection 40 is also moved from the upper left to the lower right, wherein the end 78 mounted to the projection 40 is displaced along the door or window frame 10 in a downward direction, thereby pivoting out the shackle 46 and tilting the door or window frame 10 (shown in FIG. 6 with dash-dotted lines).

FIG. 7 shows a perspective view of the differential transmission 32 with the crank 28 disposed on its upper side 80. The crank 28 serves for driving the upper side 80 and a retainer 82. Four toothed wheels 84 and 86 are each rotatably disposed in this retainer 82 in two planes, one on top of the other (shown in FIG. 8). The two toothed wheels 84 and 86 are connected to one another for secure mutual rotation. This is effected (as shown in FIG. 7) either via an intermediate disc 88 or directly (as shown in FIG. 8). The part of the differential transmission 32 shown in FIG. 7 and 8 is inserted into the hollow wheel 66 (FIG. 5) such that the toothed wheels 86 engage in the inner toothed wheel 90 of the hollow wheel 66. A hollow wheel (not shown) is disposed onto the toothed wheels 84 and is connected to the cylindrical section 26 of the housing 12 and thereby fixed.

When the transmission 32 is driven by the crank 28, the toothed wheels 84 turn about the stationary hollow wheel connected to the housing 12 thereby driving the hollow wheel 66 since the two toothed wheels 84 and 86 have different numbers of teeth.

It is regarded as being important that the rotational function of the door or window frame 10 is effected by a first drive 18 via a separate rotational armature 22, whereas the tilt function of the door or window frame is effected by a second drive 20 and a second tilt armature 24. For this reason, the invention can utilize the conventional rotational tilt-armature which, in this invention, merely effects a rotational function and the tilting function is effected by a further armature, i.e. the tilt armature 24 with shackle 46. When the door or window frame 10 is completely locked, the rotational armature 22 is initially moved by the drive 18 and crank 28 from the upper into an intermediate position in which the locking pins 74 and 92 release the door or window frame 10 for rotation. When the crank 28 is moved further, the rotational armature 22 is displaced into its final position in which the door or window frame 10 is locked such that it can only be tilted. In this neutral position, the rotational armature 22, in particular the drive 18, is decoupled from the crank 28 thereby coupling the drive 20 and the tilt armature 24. When the crank 28 is turned further, the door or window frame 10 is tilted in correspondence with the crank rotation. This means that each intermediate position between the closed door or window frame 10 and the completely tilted door or window frame 10 can be assumed. The differential transmission 22 is designed such that it is self-locking, wherein the door or window frame 10 reliably retains each intermediate position. Tilting of the door or window frame 10 is merely effected by the tilt armature 24 and not by the rotational armature 22, which remains in its neutral position.

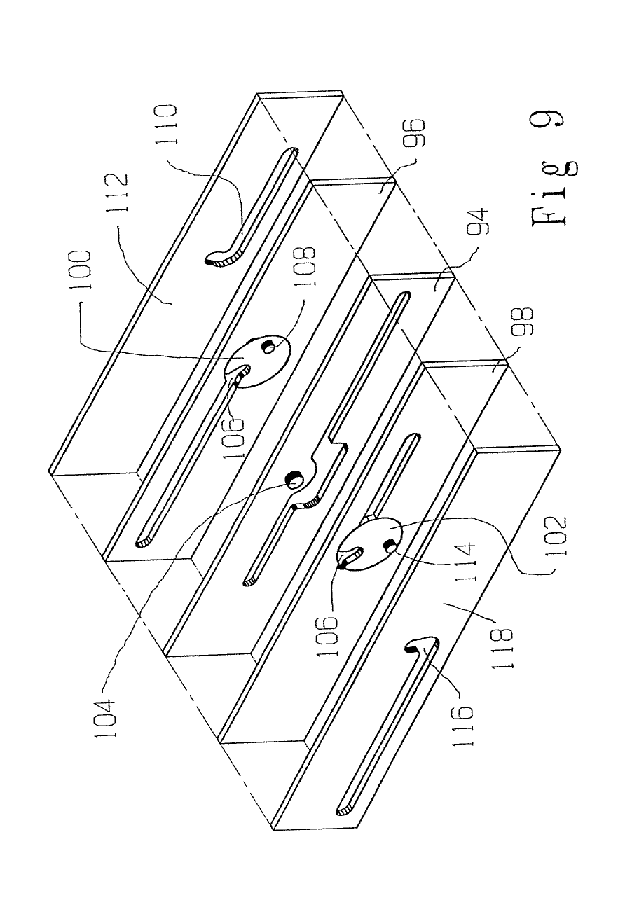

FIG. 9 shows a further embodiment of a drive having a central translating part 94, two further translating parts 96 and 98 and locking devices 100, 102 provided in a housing (not shown). The central translating part 94 is disposed in the housing and can be displaced in the longitudinal direction thereof via a crank, a turning handle or another actuating element. The central translating part 94 thereby actuates the locking devices 100, 102 (formed as control discs) via two laterally projecting pins 104. The control discs 100, 102 are rotatably disposed in round recesses of the two translating parts 96 and 98 and comprise receiving slots 106 into which the pins 104 engage. When e.g. the central translating part 94 is moved from the left to the right, the control discs 100, 102 into which the pins 104 engage, are turned by approximately 90° in a clockwise direction. The pin facing away from the observer and engaging in the control disc 100 is then retained and actuates the first translating part 96. The rotary position of the control disc 100 is secured in that a securing pin 108 projecting from the control disc 100 is disposed within a cam guide 110 provided e.g. in a housing wall 112. The first translating part 96 is thus displaced by the central translating part 94 in an outward direction (in FIG. 9 towards the right). When the central translating part 94 is pushed back, the first translating part 96 is also carried along until it once more assumes the position shown in FIG. 9.

When the central translating part 94 in FIG. 9 is moved towards the left, the two control discs 100, 102 into which the pins 104 engage, are turned in a counter-clockwise direction through approximately 90° such that they assume the position shown in FIG. 9. The pin 104 facing the observer is then captured in the control disc 102 and actuates the second translating part 98. The turned position of the control disc 102 is secured by a securing pin 114 projecting from the control disc 102 and disposed in a cam guide 116, provided e.g. in a housing wall 118.

The translating part 98 or 96 which is not actuated by the central translating part is blocked at the end of the cam guide 116 or 110 by its associated housing wall 118 or 112.

The translating parts 94, 96 and 98 may be relatively flat or thin such that this drive can be easily accommodated in a door or window frame. Moreover, the central translating part 94 can drive, via the first translating part 96, either the rotational armature or, via the second translating part 98, the tilt armature, wherein the respective other armature remains at rest.

We claim:

1. A rotational tilt-armature for a window, a door or the like, comprising:
a rotational armature;
a tilt armature;
a first drive for said rotational armature; and
a second drive for said tilt armature, wherein said rotational armature and said tilt armature are driven in sequence, one after the other.

2. A rotational tilt-armature of claim 1, wherein said rotational armature is driven when said tilt armature assumes a neutral position and wherein said tilt-armature is driven when said rotational armature assumes a neutral position.

3. The rotational tilt-armature of claim 1, further comprising a central translating part, wherein said first drive comprises a first translating part for said rotational armature and wherein said second drive comprises a second translating part for said tilt armature, wherein said central translating part actuates said first and said second translating parts.

4. The rotational tilt-armature of claim 3, wherein one of said first and said second translating parts is decoupled from said central translating part when a respective other one of said first and said second translating parts is coupled to said central translating part.

5. The rotational tilt-armature of claim 4, further comprising means for coupling and decoupling said first and said second translating parts to and from said central translating part.

6. The rotational tilt-armature of claim 1, further comprising a crank for actuating said first and said second drives.

7. The rotational tilt-armature of claim 1, further comprising a toothed gearing.

8. The rotational tilt-armature of claim 7, wherein said toothed gearing comprises a differential transmission.

9. The rotational tilt-armature of claim 1, further comprising a first toothed rod section which is one of integral with said rotational armature and connected to said first drive, and also further comprising a second toothed rod section which is one of integral with said tilt armature and connected to said second drive.

10. The rotational tilt-armature of claim 9, wherein said first and said second toothed rod sections are disposed proximate to one another, wherein said first drive comprises a first toothed wheel and said second drive comprises a second toothed wheel, wherein said first toothed wheel and said second toothed wheel are disposed one on top of the other, and further comprising means for motionally coupling said first toothed wheel to said second toothed wheel.

11. The rotational tilt-armature of claim 10, wherein said first toothed wheel has first teeth along only a part of an entire circumference thereof and said second toothed wheel has second teeth along only a part an entire circumference thereof, wherein said first and said second teeth sequentially engage said first and said second toothed rod sections.

12. The rotational tilt-armature of claim 10, further comprising toothed gearing having a differential transmission, wherein said differential transmission drives said first and said second toothed wheels.

13. The rotational tilt-armature of claim 9, further comprising a housing and locking means, said locking means cooperating with said first and said second toothed rod sections to sequentially lock said first and said second toothed rod sections to said housing such that only one of said first and said second toothed rod sections can be driven.

14. The rotational tilt-armature of claim 13, wherein said locking means comprises a locking element which is driven by one of said first and said second toothed rod sections and which locks another one of said first and said second toothed rod section to said housing.

15. The rotational tilt-armature of claim 14, wherein said locking element always re-assumes an unlocked position when changing from said first drive to said second drive and when changing from said second drive to said first drive.

16. The rotational tilt-armature of claim 1, wherein said armature comprises a pivoting shackle disposed proximate said first and said second drives.

17. The rotational tilt-armature of claim 16, wherein a free end of said shackle can be hooked into a closing plate provided on a stationary window or door casement.

18. The rotational tilt-armature of claim 17, wherein said closing plate is open when the rotational armature assumes its unlocked position.

19. The rotational tilt-armature of claim 1, further comprising means for driving said first and said second drives using a motor.
